(19) United States
(12) Patent Application Publication
(10) Pub. No.: US 2025/0340487 A1
(43) Pub. Date: Nov. 6, 2025

(54) LOW CARBON CONCRETE COMPOSITION AND A METHOD TO PRODUCE A LOW CARBON CONCRETE COMPOSITION

(71) Applicant: HOLCIM TECHNOLOGY LTD, ZUG (CH)

(72) Inventors: Christophe LEVY, HOLDERBANK (CH); Emmanuel GUILLON, HOLDERBANK (CH); Hafsa RAHOUI, HOLDERBANK (CH); Anthony PEUCHLESTRADE, HOLDERBANK (CH)

(21) Appl. No.: 18/867,617

(22) PCT Filed: May 23, 2023
(86) PCT No.: PCT/EP2023/063844

§ 371 Date: Nov. 20, 2024

(30) Foreign Application Priority Data
May 23, 2022 (EP) 22305765.4

(51) Int. Cl. C04B 28/04; C04B 14/06; C04B 14/28; C04B 18/24; C04B 20/00

(52) U.S. Cl. CPC C04B 28/04; C04B 14/06; C04B 14/28; C04B 18/24; C04B 20/0048

(57) ABSTRACT

A low carbon concrete composition and a method to produce a low carbon concrete composition, as well as to a premix comprising hydraulic binder and admixtures. A mineral ingredient includes biochar and a filler selected from limestone and/or siliceous material.

The invention relates to a low carbon concrete composition and a method to produce a low carbon concrete composition, as well as to a premix comprising hydraulic binder and admixtures.

Concrete is a very widely used construction material with high strength and good durability. In addition to sand and/or aggregates and water, it also contains Portland cement as a hydraulic binder, which produces strength-forming phases by solidifying and curing in contact with water. Concrete based on Portland cement clinker is thus one of the most important binders worldwide.

By adding various mineral components, such as, e.g., granulated blast-furnace slag, fly ash, natural pozzolans, calcined clays or ground limestone to Portland cement, Portland composite cements having different properties can be produced. At the same time, the carbon dioxide footprint of the cement can be reduced by substituting Portland clinker by the cited mineral components. The production of Portland clinker results in high carbon dioxide emissions, emitted during the calcination and decarbonation of the raw materials, and from the burning of the fuels to heat the kiln to the desired temperature of about 1,450° C. The use of mineral components in Portland cement has been an established practice for more than 100 years and is regulated in numerous cement and concrete standards.

There is therefore a strong need for cement compositions with a reduced carbon dioxide footprint.

The present invention aims at solving this problem, by providing a mineral ingredient comprising biochar which allow to mitigate climate change, via carbon sequestration. Indeed, biochar provides the benefit of reducing carbon dioxide (CO₂) in the atmosphere by serving as a material in which carbon dioxide is sequestrated. In particular, the present invention is directed to a Portland cement composition comprising biochar with good rheologic and strength properties.

### Object of the Invention

The invention is directed to a mineral ingredient for concrete/mortar composition comprising biochar and a filler selected from limestone and/or siliceous material.

Preferably, biochar is obtained by the thermal decomposition of biomass at a temperature higher than 300° C., preferably at a temperature ranging from 300 to 1,000° C.

Preferably, biochar has a maximum size of 5 mm and a minimum size of 0 mm.

Preferably, limestone filler is in the form of particles having a D90 less than or equal to 200 μm, and preferably a D97 less than or equal to 250 μm; siliceous material filler is in the form of particles having a D50 comprised between 30 to 60 μm.

The invention is also directed to a cement composition comprising mineral ingredient as described above and Portland cement.

Preferably, the composition comprises between 15 wt.-% and 50 wt.-% of the mineral ingredient, preferably between 20 wt.-% and 45 wt.-%, compared to the total weight of the composition.

Preferably, the composition comprises between 50 wt.-% and 85 wt.-% of the amount of Portland cement, preferably between 55 wt.-% and 80 wt.-%, compared to the total weight of the composition.

Preferably, Portland cement comprises a Portland clinker and an optional additional mineral component.

Preferably, the additional mineral component does not constitute more than 20% by weight of the total weight of the Portland cement and preferably ranges from 0% to 20% by weight.

The invention is also directed to a hydraulic composition for mortar and/or concrete comprising
a cement composition as described above,
sand and/or aggregates, and
water.

Preferably, the hydraulic composition comprises
at least 10% of the cement composition; and
up to 90% of sand or aggregates,
the percentages corresponding to volume proportions relative to the total volume of the hydraulic composition.

Preferably, in the hydraulic composition, the water to cement composition ratio is at least 0.3, preferentially comprised between 0.4 and 0.9.

Preferably, the hydraulic composition comprises at least one admixture selected from an accelerator, a viscosifying agent, a retarder, a clay inerting agent, a shrinkage reducing agent, a defoaming agent, a plasticizer and/or a superplasticizer, and combinations thereof.

Preferably, the hydraulic composition comprises fibers such as mineral fibers, organic fibers, metal fibers or a mixture thereof.

The invention is also directed to a process for preparing a cement composition as described above or a hydraulic composition as described above, comprising mixing the Portland cement and the mineral ingredient.

In one embodiment, in the process all the limestone and/or siliceous material comprised in the cement composition is brought only by the filler of the mineral ingredient.

In another embodiment, in the process one part of limestone and/or siliceous material comprised in the cement composition is brought only by the filler of the mineral ingredient and the other part of limestone and/or siliceous material is added to the cement composition.

The invention is also directed to an use of a mineral ingredient as described above in a cement composition as described above or in a hydraulic composition as described above.

The above and other objects, features and advantages of this invention will be apparent in the following detailed description.

### Definitions and Methods

As used herein, the term “concrete” refers to a composition comprising a cement composition of the invention and aggregates which in presence of water forms a paste which sets and hardens by means of hydration reactions and processes and which, after hardening, retains its strength and stability even under water. Specifically, concrete is as defined in the standard NF EN 206+A1:2016. The terms “concrete” and “concrete composition” will have the same meaning in the present disclosure.

As used herein, the term “mortar” refers to a composition comprising a cement composition of the invention and sand which in presence of water forms a paste which sets and hardens by means of hydration reactions and processes and which, after hardening, retains its strength and stability even under water. The terms “mortar” and “mortar composition” will have the same meaning in the present disclosure.

As used herein, the term “cement composition” refers to a composition containing Portland cement which sets and hardens by hydration and a mineral ingredient of the invention. Preferably, the Portland cement is a defined in standard NF EN 197-1 of April 2012. Portland cement may alternately comprise Portland clinker and combinations of Portland clinker with any other constituent as defined in the standard NF EN 197-1 of April 2012.

“mineral components” refer to the constituents other than Portland clinker as defined in the standard NF EN 197-1 of April 2012.

As used herein, the term “Portland cement” refers to a hydraulic binder comprising at least 50% by weight of calcium oxide (CaO) and silicon dioxide (SiO₂), in weight compared to the total weight of the cement. The cement is preferably a cement as defined in the standard NF EN 197-1 of April 2012. The Portland cements defined in standard NF EN 197-1 of April 2012 are grouped in 5 different families: CEM I, CEM II, CEM III, CEM IV and CEM V.

The mineral component comprises one or at least one of the components that are defined in paragraphs 5.2.2 to 5.2.7 of the same standard NF-EN197-1 of April 2012. Accordingly, the mineral component is selected from the group consisting of granulated blast furnace slag, pozzolanic materials, fly ashes, burnt shale, limestone, silica fume and combinations thereof.

As used herein, the term “admixture” refers to a material other than water, aggregates, cement composition, and fiber reinforcement that is used as an ingredient of concrete composition to modify its freshly mixed, setting, or hardened properties and that is added to the batch before or during its mixing. The terms “admixture” and “chemical admixture” will have the same meaning in the present disclosure.

As used herein, the term “water reducing agent” refers to an admixture which reduces the amount of mixing water by 5% to 30% in weight, preferably by 10% to 30% in weight, for a given workability. Water reducing agents that reduce the amount of mixing water by 15% to 30% in weight are also called superplasticizers.

### Determination of Particle Size Distribution by Sieving

The particle size distribution is obtained by sieving at least 100 g of biochar on 5 sieves with different sized apertures corresponding to 5 mm; 4 mm; 3.15 mm; 2 mm; 1 mm; 0.5 mm. The sieves are vibrated. The retained amount by the sieves is reported and cumulative particle size distribution is obtained.

### Method of Measurement the Particle Size Distribution

In the present description and accompanying claims, the particle size distribution is measured by laser particle size analysis, e.g. using a Malvern MS2000 laser analyzer. Measurement is performed in ethanol. The light source is a red He—Ne laser (632 nm) and blue diode (466 nm). The optical model is the Mie model and the computing matrix of polydisperse type. The apparatus is calibrated before each work session using a standard sample (C10 silica, Sibelco) with known particle size curve. Measurement is carried out with the following parameters: pump rate 2300 rpm and stirrer speed of 800 rpm. The sample is positioned to obtain 10 to 20% obscuration. Measurement is conducted after stabilization of obscuration. 80% sonication is emitted for 1 minute to ensure de-agglomeration of the sample. After about 30 seconds (to evacuate any air bubbles) the sample is measured for 15 seconds (15000 images analysed). Without emptying the cell, the measurement is repeated at least twice to verify the stability of the result and evacuation of any bubbles.

All the measurements given in the description and specified ranges correspond to the mean values obtained with ultrasound.

The particle size of sand is generally determined by screening. D90, also denoted DV90, corresponds to the 90th percentile of the volume distribution of particle size i.e. 90% of the particles are of size less than D90 and 10% are of size greater than D90. Similarly, D50 also denoted DV50, corresponds to the 50th percentile of the volume distribution of particle size i.e. 50% of the particles are of size less than D50 and 50% are of size greater than D50. Similarly, D10 also denoted DV10, corresponds to the 10 th percentile of the volume distribution of particle size i.e. 10% of the particles are of size less than D10 and 90% are of size greater than D10.

### Blaine Fineness

Blaine fineness are measured at 20° C. at a relative humidity not exceeding 65% using a Blaine Euromatest Sintco apparatus in accordance with European Standard EN 196-6:2018.

### Slump Flow of Mortar

The principle of the spread measurement consists in filling a truncated spread measurement cone with the hydraulic composition to be tested, then releasing the said composition from the said truncated spread measurement cone in order to determine the surface of the obtained disk when the hydraulic composition has finished spreading. The truncated spread measurement cone corresponds to a reproduction at the scale Y2 of the cone as defined by the NF P 18-451 Standard, 1981. The truncated spread measurement cone has the following dimensions:
top diameter: 50+/−0.5 mm;
bottom diameter: 100+/−0.5 mm; and
height: 150+/−0.5 mm.

The entire operation is carried out at 20° C. The spread measurement is carried out in the following manner:
Fill the reference cone in one single time with the hydraulic composition to be tested;
If necessary, tap the hydraulic composition to homogenously distribute it in the truncated cone;
Level the top surface of the cone;
Lift the truncated cone vertically; and
Measure the spread according to four diameters at 45° with a calliper square.

The result of the spread measurement is the average of the four values, +/−1 mm.

### Strength of Mortar

The strength is measured by preparing cement mortars. The detailed protocol is described in the European cement Standard EN 196-1 (September 2016), the only difference is that polystyrene moulds are used instead of steel moulds.

The test is carried out at 20° C.

The cement mortars are prepared as follows:

The mortar is made using a Perrier type of mixer. The entire operation is carried out at 20° C. The preparation method comprises the following steps:
Put the sands in a mixer bowl;
At T=0 second: start the mixing at low speed (140 rpm) and simultaneously add the wetting water in 30 seconds, then continue to mix at low speed (140 rpm) until 60 seconds;
At T=1 minute: stop the mixing and let rest for 4 minutes;
At T=5 minutes: (TO for the measurement method of the setting time): add the hydraulic binder;
At T=6 minutes: mix at low speed (140 rpm) for 1 minute;
At T=7 minutes: add the mixing water (+admixtures) in 30 seconds (whilst mixing at low speed (140 rpm)); and
At T=7 minutes and 30 seconds: mix at high speed (280 rpm) for 2 minutes.

### Strength of Concrete

The strength is measured in agreement with the standard NFEN 12390-3 (June 2019). The test is carried out at 20° C.

### Setting Time

The setting times is measured by maturometry, by measuring the temperature within the concrete composition as a function of time. As the chemical reactions that induce the setting of cement upon addition of water are exothermic, measuring the temperature of the concrete composition as a function of time provides a comparative assessment of setting times.

The testing protocol is the following:
Mixing the hydraulic binder, aggregates and dried chemical admixture if any
Adding water and liquid chemical admixture if any
20 minutes after adding water to the concrete composition, around 200 grams of fresh concrete composition is placed in a cylinder receptacle (4-6 cm for the basis, 10 cm height),
This receptacle is placed in a semi-adiabatic chamber whose dimensions are only slightly larger (diameter close to 8 cm maximum) than those of the receptacle to limit thermal exchanges,
A temperature sensor is placed in the fresh concrete composition and temperature is measured over time.

### Resistance to Scaling

The resistance to scaling is determined by measurements on hydraulic composition in accordance with standard XP P 18-420, 2012.

### DETAILED DESCRIPTION

### Mineral Ingredient

In one aspect, the present invention concerns a mineral ingredient comprising biochar and a filler selected from limestone and/or siliceous material.

In the mineral ingredient of the present invention, the weight ratio of biochar to filler is ranging from 0.1 to 5.0, preferentially from 0.2 to 4.0, preferentially from 0.25 to 3.0; preferentially from 0.3 to 3.4 and more preferentially from 0.4 to 3.0.

Biochar used in a mineral ingredient in accordance with the invention provides the benefit of reducing carbon dioxide (CO₂) in the atmosphere by carbon sequestration. Thus, the use of biochar in a cement has the potential to help mitigate climate change, via carbon sequestration.

### Biochar

A biochar according to the invention, also called charcoal, designates a solid porous carbonaceous material which is produced by thermal decomposition of biomass.

Biochar is obtained by the thermal decomposition of biomass at a temperature higher than 300° C., preferably at a temperature ranging from 300 to 1000° C., preferably from 350 to 900° C., preferably from 400 to 800° C. and more preferably from 450 to 700° C. Advantageously, the heat treatment is a pyrolysis carry out at a temperature of above 550° C.

Preferably, the biomass is selected from any type of biomass, preferably from biomass of the solid type, and in particular from biomass of the lignocellulosic type. Non-limitative examples of types of biomasses relate to wood-based biomass for example wood waste such as recycled crushed wood from demolition or furniture, residues from agricultural operations (in particular straw, maize cobs), residues from forestry operations, products from forestry operations, residues from sawmills and dedicated crops, for example short rotation coppice, or residues from microalgaes. Preferably, biomass is a wood-based biomass.

In a preferred embodiment, the biochar has a maximum size of 5 mm, preferably 4 mm and more preferably 3.5 mm. The biochar has advantageously a minimum size of 0 mm and preferably of 0.063 mm.

The biochar according to the present invention advantageously is in the form of particles where at least 65% of the particles have a size of less than 2 mm, determined by sieving.

By way of example, the biochar particles can have particle sizes as shown or measured in Table 1 below.

TABLE 1

| Size range (sieve) | % above | % below |
|---|---|---|
| 4 mm-5 mm | 0.3 | 99.7 |
| 3.15 mm-4 mm | 2.6 | 97.4 |
| 2 mm-3.15 mm | 13.0 | 87.0 |
| 1 mm-2 mm | 38.6 | 61.4 |
| 0.5 mm-1 mm | 67.0 | 33.0 |
| <0.5 mm | 100.0 | 0.0 |

### Filler

The filler in accordance with the invention is selected from limestone and/or siliceous material.

The limestone used in the filler is as defined in the standard EN197-1 of April 2012. It comprises ground calcium carbonate, the calcium carbonate content calculated from the calcium oxide content is at least 75% by weight of the weight of the limestone. In an embodiment, the clay content, determined by the methylene blue test in accordance with EN 933-9 of June 2013, shall not exceed 1.2% by weight of the total weight of the limestone. The total organic carbon (TOC) content, when tested in accordance with EN 13639 of September 2017, shall not exceed 0.5% by weight of the total weight of the limestone.

Advantageously, limestone of the filler is in the form of particles having a D90 less than or equal to 200 μm, and preferably a D97 less than or equal to 250 μm. Advantageously, limestone used in the filler is in the form of particles having a D90 ranging from 30 to 200 μm, preferably in the form of particles having a D97 ranging from 50 to 200 μm. Advantageously, limestone used in the filler is in the form of particles having a D50 ranging from 5 to 25 μm, advantageously from 6 to 20, and more advantageously from 7 to 12.

Advantageously, the limestone of the filler is composed of several fractions, such as two fractions, characterized by different finenesses. Using several fractions of limestone has the advantage of improving the particle packing density of the filler, and the concrete. This will improve both the rheology and the strength development of the resulting concrete and mortar.

Preferably, limestone is in the form of particles having a D90 less than or equal to 200 μm, and preferably a D97 less than or equal to 200 μm.

Advantageously, limestone has an estimated Blaine fineness comprised between 2000 cm²/g and 18000 cm²/g and preferably between 3000 cm²/g and 15000 cm²/g.

Advantageously, siliceous material of the filler is selected from amorphous silica such as silica fume, or crystalline silica such a quartz.

Advantageously, siliceous material of the filler is in the form of particles having a D50 comprised between 30 to 60 μm, a D90 less than or equal to 200 μm, preferably comprised between 150 and 200 μm and D10 comprised between 5 and 10 μm, determined by sieving.

Siliceous material used in the filler can be a siliceous fly ash consists essentially of reactive silicon dioxide and aluminium oxide. The remainder contains iron oxide and other compounds. The reactive silicon dioxide content is preferably more than 25 wt.-%.

Advantageously, the combination of biochar and a filler according to the invention allows a significant carbon sequestration.

### Cement Composition

In one other aspect, the invention relates to a cement composition comprising mineral ingredient as described above, and Portland cement.

The cement composition comprises between 15 wt.-% and 50 wt.-% of the mineral ingredient of the present invention, preferably between 20 wt.-% and 45 wt.-% and more preferably between 25 wt.-% and 40 wt.-%.

The cement composition comprises between 50 wt.-% and 85 wt.-% of the amount of Portland cement, preferably between 55 wt.-% and 80 wt.-% and more preferably between 60 wt.-% and 75 wt.-%.

Advantageously, a cement composition containing a mineral ingredient in accordance with the invention shows good rheological, strength and durability performances. Thus, the use of a cement of the invention allows carbon sequestration to reduce the carbon dioxide footprint.

### Portland Cement

Portland cement comprises a Portland clinker and an optional additional mineral component.

Portland clinker is as defined in the standard EN197-1 of April 2012, and is made by sintering a precisely specified mixture of raw materials (raw meal, paste or slurry) containing elements, usually expressed as oxides, CaO, SiO2, Al2O3, Fe2O3 and small quantities of other materials. The raw meal, paste or slurry is finely divided, intimately mixed and therefore homogeneous. Portland clinker is a hydraulic material which shall consist of at least two-thirds by weight of calcium silicates (3CaO·SiO₂ and 2CaO·SiO₂), the remainder consisting of aluminium and iron containing clinker phases and other compounds. The weight ratio (CaO)/(SiO2) shall be not less than 2.0 and the content of magnesium oxide (MgO) shall not exceed 5.0% by weight, compared to the total weight of the Portland clinker.

Optionally, Portland cement further comprises additional mineral components.

In some embodiment, the additional mineral component is fly ash used which is a mineral component as defined in the standard EN197-1 of April 2012. Fly ash is generally obtained by electrostatic or mechanical precipitation of dust-like particles from the flue gases from furnaces fired with pulverized coal. Fly ash may be siliceous or calcareous in nature.

Siliceous fly ash consists essentially of reactive silicon dioxide and aluminium oxide. The remainder contains iron oxide and other compounds. The proportion of reactive calcium oxide is preferably less than 10% by weight. The reactive silicon dioxide content is preferably more than 25% by weight.

Calcareous fly ash consists essentially of reactive calcium oxide, reactive silicon dioxide and aluminium oxide. The remainder contains iron oxide and other compounds. The proportion of reactive calcium oxide is preferably more than 10.0% by weight, more preferably more than 15% by weight.

Advantageously, optional fly ash used in the Portland cement is in the form of particles having a D50 comprised between 30 to 60 μm.

In some embodiment, the additional mineral component is different from the filler of the mineral ingredient described above. All those listed in the Portland cement standards EN 197-1 of April 2012, are suitable. Granulated blast furnace slags, pozzolanic materials such as calcined clays, burnt shale, silica fume and combinations thereof are particularly advantageous. More specifically, slag, calcined clay and combinations thereof are particularly advantageous. More specifically, silica fume is particularly advantageous when the mineral addition is fly ash.

Preferably, the additional mineral component does not constitute more than 20% by weight of the total weight of the Portland cement. Preferably, the additional mineral component content ranges from 0% to 20% by weight, more preferably from 0.5% to 15% by weight, even more preferably from 1% to 10% by weight for 100% in weight of Portland cement.

The Portland cement may further comprise calcium sulphate.

Calcium sulphate used according to the present invention includes gypsum (calcium sulphate dihydrate, CaSO₄·2H₂O), hemi-hydrate (CaSO₄·½H₂O), anhydrite (anhydrous calcium sulphate, CaSO₄) or a mixture thereof. The gypsum and anhydrite exist in the natural state. Calcium sulphate produced as a by-product of certain industrial processes may also be used. Preferably, the calcium sulphate content ranges from 0% to 8% by weight for 100% in weight of Portland cement and preferably from 1% to 7% by weight for 100% in weight of Portland cement.

Advantageously, the cement composition consists in Portland cement, which may comprise calcium sulphate, mineral ingredient disclosed above, wherein the sum of all is 100% in weight of cement composition.

Advantageously, all the constituents of cement composition including the biochar and the filler preferably the limestone, are co-ground with Portland clinker, eventually with a source of calcium sulphate, any additional mineral component, and optionally a grinding aid. Alternatively, the cement composition can be prepared by blending all of the pre-ground constituents in a blending plant.

### Hydraulic Composition for Mortar or Concrete

In one other aspect, the invention relates to a hydraulic composition for mortar and/or concrete, abbreviated mortar/concrete, comprising
a cement composition as described above,
aggregates or sand, and
water.

Advantageously, the hydraulic composition according to the invention has an improved durability. In particular, said composition has an enhanced resistance to scaling compared to a reference hydraulic composition not comprising a mineral ingredient of the invention as described above. Preferably, the hydraulic composition in accordance with the invention presents a reduction of the mass loss by scaling of at least 50 wt.-%, preferably of at least 60 wt.-%, preferably of at least 70 wt.-% and more preferably of at least 80 wt.-% compared to a reference hydraulic composition which does not comprise a mineral ingredient of the invention as described above.

Preferably, the resistance to scaling is less than or equal to 750 g/m², preferably less than or equal to 600 g/m², measured according the standard XP 18-420, 2012.

### Aggregates/Sand

Any known sand suitable for the preparation of concrete or mortar is suitable for the present invention. The sand has advantageously a maximum size of 5 mm, preferentially 4 mm.

The sand has advantageously a minimum size of 0 mm or of 0.063 mm. Preferably, the sand is a siliceous sand such as quartz sand, a calcined or non-calcined bauxite sand, a silica-calcareous sand or mixtures thereof.

Any known aggregates suitable for the preparation of concrete may be used for the present invention. The aggregates have advantageously a maximum size of 32 mm.

The aggregates can comprise gravel and optionally sand.

The sand in aggregates is as disclosed above.

The gravel has advantageously a minimum size greater than 4 mm and preferably greater than 5 mm and preferably a maximum less than or equal to 32 mm, preferably a maximum less than or equal to 28 and more preferably a maximum less than or equal to 25 mm).

The hydraulic composition advantageously comprises:
at least 10% of the cement composition as described above; and
up to 90% of sand or aggregates,
the percentages corresponding to volume proportions relative to the total dry volume.

When the aggregates comprise sand and gravel, the mass ratio of the quantity of sand to the quantity of gravel is preferably from 1.5:1 to 1:1.8, more preferably from 1.25:1 to 1:1.4, even more preferably from 1.2:1 to 1:1.2.

### Water

For mortar or concrete application, the mortar/concrete composition comprises water. As used herein, the term “water” used with regard to the concrete composition preferably includes the water added for mixing and eventually the water of the admixtures, such as the water of water reducing agent.

The water content is expressed in a water to cement composition weight ratio. The water to cement composition ratio is at least 0.3, preferentially comprised between 0.4 and 0.9, more preferentially between 0.5 and 0.8.

### Admixtures

The hydraulic composition according to the invention may also comprise at least an admixture, for example one of those described in the EN 934-2 standards as of September 2002, EN 934-3 standard as of November 2009 or EN 934-4 as of August 2009, and optionally mineral additions.

The hydraulic compositions according to the invention may comprise at least one admixture for a hydraulic composition, selected from an accelerator, a viscosifying agent, a retarder, a clay inerting agent, a shrinkage reducing agent, a defoaming agent, a plasticizer and/or a superplasticizer, and combinations thereof.

It should be noted that these admixtures may be added to the cement composition or to the hydraulic composition according to the invention.

In a preferred embodiment, the hydraulic composition according to the invention may further comprise a fluidifying agent, a superplasticizer, accelerator and/or a retarder. The term of “superplasticizer” herein is to be understood as including both water reducing agents and superplasticizers as described in the book entitled “Concrete Admixtures Handbook, Properties Science and Technology”, V. S. Ramachandran, Noyes Publications, 1984.

A water reducing agent is defined as an admixture which typically reduces the amount of mixing water by 10 to 15% for a given workability. The water reducing agents include, for example lignosulfonates, hydroxycarboxylic acids, carbohydrates and other specialized organic compounds, e.g. glycerol, polyvinyl alcohol, sodium alumino-methyl-siliconate, sulfanilic acid and casein.

The superplasticizers belong to a new class of water reducing agents, chemically different from normal water reducing agents and capable of reducing the amounts of water by about 30%. Super-plasticizers have been globally classified in four groups: sulfonated condensates of naphthalene formaldehyde (SNF) (generally a sodium salt); sulfonate condensates of melamine formaldehyde (SMF); modified lignosulfonates (MLS); and others. More recent super-plasticizers include polycarboxylic compounds such as polycarboxylates, e.g. polyacrylates. A super-plasticizer is preferably a new generation super-plasticizer, e.g. a copolymer containing a polyethylene glycol as a grafted chain and carboxylic functions in the main chain like a polycarboxylic ether. Sodium polycarboxylates-polysulfonates and sodium polyacrylates may also be used. The derivatives of phosphonic acid may also be used. The required amount of super-plasticizer generally depends on the reactivity of the cement. The lower the reactivity, the smaller is the required amount of super-plasticizer. In order to reduce the total amount of alkaline salts, the super-plasticizer may be used as a calcium salt rather than as a sodium salt.

Derivatives of phosphonic acids may also be used. Sodium polycarboxylate-polysulfonates and sodium polyacrylates may also be used. The required amount of super-plasticizer generally depends on the reactivity of the cement. The lower the reactivity, the smaller is the required amount of super-plasticizer. In order to reduce the total content of alkaline salts, the super-plasticizer may be used as a calcium salt rather than as a sodium salt.

The superplasticizing agents may be liquid form with a solid content comprised between 10 and 60 wt.-%, preferably between 20 and 40 wt.-%

The viscosifying agent comprise derivatives of cellulose, for example cellulose ethers soluble in water, such as sodium carboxymethyl, methyl, ethyl, hydroxyethyl and hydroxypropyl ethers; alginates; and xanthan, carrageenan or guar gum. A mixture of these agents may be used.

The hydraulic composition according to the invention may further comprise an accelerator and/or a retarder. However, it has to be noted the high early strength values may be obtained without any need to include a chemical accelerator. This is of interest as such chemical accelerators usually increase the strength development but have a negative effect of the fresh concrete rheology, and especially the slump retention time.

The defoaming agent includes phosphates, such as tri-isobutyl phosphate, and/or silicones, such as polydimethylsiloxane, and combinations thereof. The defoaming agent can be in the form of a solution, a solid or preferably in the form of a resin, an oil or an emulsion, preferably in water. More particularly suitable are silicones comprising (RSiO_{0.5}) and (R₂SiO) moieties. In these formulae, the R radicals, which may be the same or different, are preferably hydrogen or an alkyl group of 1 to 8 carbon atoms, the methyl group being preferred. The number of moieties is preferably from 30 to 120.

### Fibers

The hydraulic composition according to the invention may further comprise fibers, for example mineral fibers (e.g. glass, basalt), organic fibers (e.g. plastic of APV type), metal fibers (e.g. steel) or a mixture thereof.

The organic fibers may notably be selected from among polyvinyl alcohol (PVA) fibers, poly-acrylonitrile (PAN) fibers, high density polyethylene (HDPE) fibers, polyamide or polyimide fibers, polypropylene fibers, aramid fibers or carbon fibers. Mixtures of these fibers may also be used.

These organic fibers may appear as an object either consisting of single strand or multiple strands, the diameter of the object ranging from 25 microns to 800 microns. The individual length of the organic fibers is preferably comprised between 10 and 50 mm.

As for metal fibers, these may be metal fibers selected from among steel fibers such as high mechanical strength steel fibers, amorphous steel fibers, or further stainless steel fibers. Optionally, the steel fibers may be coated with a non-ferrous metal such as copper, zinc, nickel (or their alloys).

The individual length of the metal fibers is preferably of at least 2 mm and is, even more preferentially, comprised in the range 10-30 mm.

Fibers which are notched, corrugated or hooked-up at the ends may be used.

The amount of fibers is advantageously comprised from 0.1 to 6%, even more preferentially from 1 to 5% of the volume of the hydraulic composition.

Resorting to mixtures of fibers with different features gives the possibility of adapting the properties of the concrete with respect to the sought features.

It should be noted that the fibers may be added to the cement composition or to the mineral ingredient according to the invention.

The hydraulic composition according to the invention may be prepared by mixing the cement composition according to the invention with aggregates or sand and water.

### Mixing

Mixing can be done by any known methods.

In one embodiment, the cement composition is prepared during a first step wherein the Portland cement, the mineral ingredient and optionally chemical admixtures are mixed. The concrete or mortar composition can be prepared in a subsequent step wherein the aggregates, sand and/or water are added. Advantageously, all the limestone and/or siliceous material comprised in the cement composition is brought only by the filler of the mineral ingredient.

In another embodiment, one part of limestone and/or siliceous material comprised in the cement composition is brought only by the filler of the mineral ingredient and the other part of limestone and/or siliceous material is added to the cement composition. However, in the cement composition, the weight ratio of biochar to filler is ranging from 0.1 to 5.0, preferentially from 0.2 to 4.0, preferentially from 0.25 to 3.0; preferentially from 0.3 to 3.4 and more preferentially from 0.4 to 3.0.

In another embodiment, a premix composition for concrete/mortar is prepared during a first step wherein the Portland cement, the mineral ingredient, optionally chemical admixtures and sand or aggregates are mixed. The concrete or mortar composition can be prepared in a subsequent step wherein water is added to the premix composition.

In that variant, the cement composition is mixed with aggregates and the resulting mix can be mixed with water later. That resulting premix composition for concrete is a dry ready-mix concrete, usable by simply mixing with water.

In that variant, the cement composition is mixed with sand and the resulting premix composition for mortar can be mixed with water later. That resulting premix composition for mortar is a dry ready-mix mortar, usable by simply mixing with water.

In another embodiment, the cement composition is prepared during a first step, and the aggregates or sand and water are added during a subsequent step.

Calcium sulphate, if any, is added during the first step.

Chemical admixtures can be added during the first step if they are in a dried state or supported on inorganic particles. Liquid chemical admixtures can be added during the subsequent step.

In a preferred embodiment, a premix composition comprising the cement composition, the admixtures and optionally the calcium sulphate is first prepared. In that embodiment, admixtures are in a dried state, preferably flash dried, or supported on inorganic particles.

In all embodiments, the mixing is done using a conventional mixer at a concrete mixing plant or directly in a drum-truck mixer, for a mixing time usual in the field.

The concrete composition of the invention may be cast to produce, after hydration and hardening a cast or precast article for the construction field. Such cast or precast articles, that comprise the concrete composition of the invention, also constitute an object of the invention. Cast or precast articles for the construction field include, for example, a slab, a floor, a screed, a foundation, a wall, a partition wall, a beam, a work top, a pillar, a bridge pier, a masonry block of concrete, optionally foamed concrete, a pipe, a conduit, a post, a stair, a panel, a cornice, a mold, a road system component (for example a border of a pavement), a roof tile, a surfacing (for example of a road), a jointing plaster (for example for a wall) and an insulating component (acoustic and/or thermal).

The invention makes it possible to respond to the need to reduce CO₂ emissions while having concrete/mortar composition with excellent rheological properties.

The invention is also directed to the use of the mineral ingredient as defined above to reduce CO₂ emissions, preferably in a cement composition and more preferably in a hydraulic composition for mortar/concrete comprising:
a cement composition as described above,
aggregates or sand,
water.

### EXAMPLES

The following examples illustrate the invention without limiting it.

### Raw Materials:

Cement: CEM I (with SS Blaine of 4420 cm²/g) and CEM II/B-M (LL-S) 42.5 N with SS Blaine of 4550 cm²/g. Both cements are supplied by Lafarge France (site Le Teil) Biochar: The biochar is wood-based biomass wherein particles have particle sizes as disclosed in Table 1 above

Limestone: BL200 is grounded limestone supplied by Omya under the brand name Betocarb, D50 is 6 μm.

Siliceous filler: silica filler supplied by Sibelco under the brand name Millisil C4 with a D50 of 56 μm.

Water reducing agent: commercial agent provided by Chryso under the commercial name Chryso Quand 630 abbreviated as Chryso Quad630.

Defoaming agent: Tri-isobutyl phosphate (TIBP).

Superplasticizer: is Tempoflow 464, provided by Sika.

Sand: 0-4 mm sand supplied by Lafarge France (carrier of St Bonnet La Petite Craz)

Gravel: 2 types of gravel wherein type 1 is of a size 5-10 mm and type 2 is of size 10-22 mm, both types of gravels are supplied by Lafarge France (carrier of St Bonnet La Petite Craz).

In all tests, the content of liquid chemical admixture, if any, is expressed in weight % of solid content in liquid admixture compared to total weight of the binder.

In the following example in accordance with the invention, all concrete compositions have a volume of 1 m³. Biochar having a different density than the cement constituents, inert components have been chosen as a variable of adjustment. Then the sand and/or the gravel content varies, so as to maintain concrete compositions having a volume of 1 m³.

TIBP is a standard defoaming agent, used here to make sure that the differences observed are not the consequence of different amounts of entrained air in the fresh concrete composition. Even present in all examples, it is not an essential feature of the present invention.

### Example 1

Compositions of mortar are described in the following table 2.

TABLE 2

| | | | | | | |
|---|---|---|---|---|---|---|
| # | F01 | F02 | F03 | F04 | F05 | F06 |

Formulations

| | | | | | | |
|---|---|---|---|---|---|---|
| Cement (g) | 450 | 450 | 450 | 450 | 450 | 450 |
| Limestone filler (g) | 0 | 0 | 207 | 207 | 0 | 0 |
| Siliceous filler (g) | 0 | 0 | 0 | 0 | 207 | 207 |
| Sand 0/4 (g) | 1373 | 985 | 1178 | 785 | 1178 | 785 |
| Biochar 0/5 (g) | 0 | 73.5 | 0 | 73.5 | 0 | 73.5 |
| Chryso Quad630 | 0.05 | 0.05 | 0.05 | 0.05 | 0.05 | 0.05 |
| (wt.-% of cement) | | | | | | |
| TIBP (wt.-% of cement) | 0.04 | 0.04 | 0.04 | 0.04 | 0.04 | 0.04 |
| Water (+/−2) (g) | 287 | 287 | 287 | 287 | 287 | 287 |
| Biochar/Filler ratio (wt./wt.) | 0 | N.A. | 0 | 0.4 | 0 | 0.4 |

Results

| | | | | | | |
|---|---|---|---|---|---|---|
| Slump flow at 5 minutes (cm) | 12 | 5.5 | 11 | 9 | 9 | 8 |
| Initial setting time (h) | 4 | 4.5 | 4 | 3.5 | 3 | 3 |

N.A.: not applicable

The slump and setting time of the mortar compositions are measured in accordance with method described above. All tests are carried out at 20° C.

Results in table 2 shows that comparing:
F01 and F02 addition of biochar to formula without filler (ie limestone or siliceous) leads to reduction of the slump from value of 12 to 5.5 cm
F03 and F04: addition of biochar to mortar with limestone leads to a reduction of the slump from 11 cm to 9 cm, the combination of limestone and biochar limits the reduction of slump.
F06 and F05: addition of biochar to mortar with siliceous filler leads to a reduction of the slump from 9 cm to 8 cm, the combination of siliceous and biochar limits the reduction of slump.

### Example 2

Compositions of concrete are described in the following table 3. The following formulations of concrete composition are normalized to 1 m³ as explained above.

TABLE 3

| | Concrete | Concrete |
|---|---|---|
| | composition F07 | composition F08 |
| Sand 0/4 (kg/m3) | 825 | 805 |
| Gravel 5/10 (kg/m3) | 360 | 352 |
| Gravel 10/22) (kg/m3) | 645 | 630 |
| Biochar (kg/m3) | 0 | 49 |
| Cement (kg/m3) | 289 | 282 |
| Limestone filler (kg/m3) | 32 | 31 |
| Chryso Quad630 (L/m3) | 1.7 | 3.0 |
| TIBP (L/m3) | 0.2 | 0.2 |
| Water (+/−2) (kg) | 167 | 167 |
| Air (vol.-%) | 1.8 | 2.3 |
| Biochar/Filler ratio (wt./wt.) | 0 | 1.6 |

Table 4 below shows the scaling resistance measurements on concrete composition without and with biochar respectively F07 and F08 which have been measured according to standard XP P 18-420, 2012. 56 cycles of freeze thaw in presence of saline solution as prescribed by the standard XP P18-420, 2012. In table 4, the term “M” corresponds to the loss of surface of concrete expressed in mass for 1 square meter of concrete.

TABLE 4

Concrete composition:

| | F07 | F08 according |
|---|---|---|
| | comparative | to the invention |
| Cycles number | M [g/m²] | M [g/m²] |
| 7 cycles | 1 | 1 |
| 14 cycles | 295 | 9 |
| 21 cycles | 1148 | 50 |
| 28 cycles | 2165 | 114 |
| 35 cycles | 3296 | 193 |
| 42 cycles | 4170 | 305 |
| 49 cycles | 4633 | 619 |
| 56 cycles | 4741 | 757 |

Results in table 4 demonstrate that the concrete composition of the invention comprising a mineral ingredient i.e biochar and limestone presents an enhanced resistance to scaling and thus an enhanced durability.

### Example 3

Compositions of concrete tested are described in the following table 5. The following formulations of concrete composition are normalized to 1 m³ as explained above. Concretes of table 5 are designed so as to be at equivalent initial rheology.

TABLE 5

| | F09 | F10 | F11 | F12 |
|---|---|---|---|---|
| | compar- | according to | compar- | according to |
| | ative | the invention | ative | the invention |
| Sand 0/4 (kg/m3) | 790 | 610 | 791 | 746 |
| Gravel 5/10 | 218 | 212 | 243 | 242 |
| (kg/m3) | | | | |
| Gravel 10/22) | 758 | 740 | 844 | 843 |
| (kg/m3) | | | | |
| Biochar (kg/m3) | 0 | 98 | 0 | 50 |
| Cement (kg/m3) | 293 | 283 | 280 | 280 |
| Limestone filler | 94 | 92 | 31 | 31 |
| (kg/m3) | | | | |
| Superplasticizer | 0.2 | 3.1 | 2.5 | 3.8 |
| (L/m3) | | | | |
| TIBP (L/m3) | 0 | 0.2 | 0 | 0.2 |
| Water (+/−2) (kg) | 178 | 174 | 154 | 154 |
| Air (vol.-%) | 1.5 | 3.9 | 1.8 | 1.8 |
| Biochar/Filler | 0 | 1.06 | 0 | 1.6 |
| ratio (wt./wt.) | | | | |

Tables 6 to 9 below shows the measurements of expansion and the fundamental bending resonant frequency on concrete composition with and without biochar respectively F10, F12 and F09, F11 submitted to freeze thaw cycles.

For each concrete formulation, 3 samples of geometry 10×10×40 cm have been prepared.

The freeze thaw test (Freezing in air-Thawing in water) is performed with up to 300 cycles according to the standard NF P 18-425 of May 2008.

During freeze thaw test, the expansion, noted “ΔLength”, and fundamental bending resonant frequency, noted “FF”, are measured according to standard NF P18-414 of December 2017.

The ratio FFn²/FFo²*100(%) is computed. The term “FFn” correspond to the fundamental bending resonant frequency at cycle n. The term “FFo” correspond to the fundamental bending resonant frequency of origin, corresponding to measurement before the start of the cycles of freeze thaw.

In tables 6 to 9, tests on concrete compositions F09 to F12 are interrupted when the ratio FFn²/FFo²*100 is lower than 60%. Values of the expansion and the ratio given in tables 6 to 9 are the median of the measurements made on the 3 samples for each concrete composition.

TABLE 6
F09 comparative

| Cycles | ΔLength | FFn²/ |
|---|---|---|
| number | (μm/m) | FFo²*100 (%) |
| 0 | 0 | 100 |
| 30 | 42 | 97 |
| 59 | 117 | 97 |
| 89 | 167 | 97 |
| 118 | 300 | 95 |
| 150 | 483 | 86 |
| 178 | 894 | 80 |
| 208 | 1072 | 77 |
| 236 | 1294 | 74 |
| 266 | 1717 | 67 |
| 300 | 2150 | 35 |

TABLE 7
F10 according to the invention

| Cycles | ΔLength | FFn²/ |
|---|---|---|
| number: | (μm/m) | FFo²*100 (%) |
| 0 | 0 | 100 |
| 30 | −22 | 98 |
| 59 | −14 | 98 |
| 91 | −72 | 99 |
| 117 | −111 | 99 |
| 150 | −42 | 100 |
| 190 | −75 | 99 |
| 219 | −11 | 100 |
| 248 | −64 | 101 |
| 268 | −222 | 102 |
| 300 | −169 | 102 |

TABLE 8
F11 comparative

| Cycles | ΔLength | FFn²/ |
|---|---|---|
| number: | (μm/m) | FFo²*100 (%) |
| 0 | 0 | 100 |
| 28 | −11 | 95 |
| 58 | 269 | 93 |
| 87 | 344 | 91 |
| 119 | 556 | 82 |
| 146 | 781 | 71 |
| 179 | 1178 | 64 |
| 219 | 1475 | 48 |

TABLE 9
F12 according to the invention

| Cycles | ΔLength | FFn²/ |
|---|---|---|
| number: | (μm/m) | FFo²*100 (%) |
| 0 | 0 | 100 |
| 28 | −58 | 98 |
| 58 | −56 | 99 |
| 87 | −81 | 99 |
| 119 | −117 | 100 |
| 146 | −94 | 100 |
| 179 | −103 | 101 |
| 219 | −72 | 100 |
| 248 | −67 | 101 |
| 277 | −78 | 100 |
| 297 | −161 | 102 |

Results in tables 6 to 9 demonstrate that the concrete compositions (F10, F12) according to the invention containing biochar and limestone show a lower expansion and higher ratios FFn²/FFo²*100 than the corresponding comparative compositions (F09, F11). This demonstrates that formulations of concrete according to the present invention have a better durability, as the resistance to freeze-thaw cycles is improved.

Further, the concrete formulations according to the invention (F10, F12) do not reach the limits of 500 μm/m of expansion and of 60% of the ratio FFn²/FFo²*100 as defined by the standard, whereas the comparative concrete formulations (F09, F11) surpass these limits.

1. A mineral ingredient for concrete/mortar composition comprising biochar and a filler selected from limestone and/or siliceous material.

2. The mineral ingredient according to claim 1, wherein the weight ratio between biochar and filler is ranging from 0.1 to 5.0.

3. The mineral ingredient according to claim 1, wherein biochar is obtained by the thermal decomposition of biomass at a temperature higher than 300° C.

4. The mineral ingredient according to claim 1, wherein biochar has a maximum size of 5 mm and a minimum size of 0 mm.

5. The mineral ingredient according to claim 1, wherein limestone filler is in the form of particles having a D90 less than or equal to 200 μm; siliceous material filler is in the form of particles having a D50 comprised between 30 to 60 μm.

6. A cement composition comprising mineral ingredient according to claim 1, and Portland cement.

7. The cement composition according to claim 6, comprising between 15 wt.-% and 50 wt.-% of the mineral ingredient compared to the total weight of the composition.

8. The cement composition according to claim 6, comprising between 50 wt.-% and 85 wt.-% of the amount of Portland cement, compared to the total weight of the composition.

9. The cement composition according to claim 6, wherein Portland cement comprises a Portland clinker and an optional additional mineral component.

10. The cement composition according to claim 9, wherein the additional mineral component does not constitute more than 20% by weight of the total weight of the Portland cement.

11. A hydraulic composition for mortar and/or concrete comprising
a cement composition according to claim 6,
sand and/or aggregates, and
water.

12. The hydraulic composition according to claim 11, comprising
at least 10% of the cement composition; and
up to 90% of sand or aggregates,
the percentages corresponding to volume proportions relative to the total volume of the hydraulic composition.

13. The hydraulic composition according to claim 11, wherein the water to cement composition ratio is at least 0.3, preferentially comprised between 0.4 and 0.9.

14. The hydraulic composition according to claim 11, further comprising at least one admixture selected from an accelerator, a viscosifying agent, a retarder, a clay inerting agent, a shrinkage reducing agent, a defoaming agent, a plasticizer and/or a superplasticizer.

15. The hydraulic composition according to claim 11, further comprising fibers.

16. A process for preparing a cement composition according to claim 6, comprising mixing the Portland cement and the mineral ingredient.

17. The process according to claim 16, wherein all the limestone and/or siliceous material comprised in the cement composition is brought only by the filler of the mineral ingredient.

18. The process according to claim 16, wherein one part of limestone and/or siliceous material comprised in the cement composition is brought only by the filler of the mineral ingredient and the other part of limestone and/or siliceous material is added to the cement composition.

19. A method comprising utilizing a mineral ingredient as defined in any one of the preceding claims in a cement composition as defined in claim 6.

20. A process for preparing a hydraulic composition according to claim 11, comprising mixing the Portland cement and the mineral ingredient.
